(19) United States
(12) Patent Application Publication
(10) Pub. No.: US 2019/0309108 A1
(43) Pub. Date: Oct. 10, 2019

(54) STABILIZED SULFONATED POLYSTYRENE SOLUTIONS

(71) Applicant: Akzo Nobel Chemicals International B.V., Amhem (NL)

(72) Inventors: John Douglas NOWAK, Yonkers, NY (US); Mohammad Abdur RAHMAN, Pomona, NY (US); Xiaowen HOU, Ridgefield, CT (US); Elliot Isaac BAND, Pleasantville, NY (US); Hua YU, Scarsdale, NY (US)

(21) Appl. No.: 16/464,734

(22) PCT Filed: Nov. 29, 2017
(86) PCT No.: PCT/EP2017/080763

§ 371 Date: May 29, 2019

Related U.S. Application Data
(60) Provisional application No. 62/429,220, filed on Dec. 2, 2016.

(30) Foreign Application Priority Data
Dec. 23, 2016 (EP) 16206720.1

(51) Int. Cl. C08F 112/08; C08K 5/13; C08L 25/18; C08F 8/36

(52) U.S. Cl. CPC C08F 112/08; C08K 5/13; C08L 2201/08; C08F 8/36; C08L 2201/54; C08L 25/18

(57) ABSTRACT

The present invention relates to a method of stabilizing an aqueous solution of polystyrene sulfonic acid and the compositions therein. This disclosure provides polymer stability in that there is minimal deterioration of the molecular weight of said polymers at or around 25° C. and the stabilizers of the disclosure reduce the need for low temperature refrigeration during transport and storage of polystyrene sulfonic acid.

### FIELD OF INVENTION

The present invention relates to an aqueous composition comprising a polymer or co-polymer of sulfonated polystyrene and a phenol derivative. Also the invention provides a method for stabilizing aqueous solutions of sulfonated polystyrene, particularly in the acidic form.

### BACKGROUND

Sulfonated polystyrene, SPS, or a copolymer with sulfonated polystyrene units, is used in many applications. It is used as a superplastifier in cement, as a dye improving agent for cotton, and as proton exchange membranes in fuel cell applications. In the acid form, polystyrene sulfonic acid (PSSA), the resin is used as a solid acid catalyst in organic synthesis and of particular importance to the electronics industry as a component of electro-conductive films.

For all of these applications the molecular weight is related to the properties of the (co)polymer in the application where it is being used. Good control of the molecular weight is possible with today's modern polymerization techniques, so that sulfonated polystyrene can be prepared to meet the exact requirements of the application at hand.

However, PSSA and copolymers with styrene sulfonic acid groups, are particularly unstable in aqueous solution and requires storage at low temperature to maintain the molecular weight at which it was produced. Accordingly, the primary method of shipment from manufacturer to formulator is as the salt form, as in polystyrene sulfonate (PSS). This is because PSS is more stable in aqueous solution.

PSSA can be converted into PSS by adding a neutralizing agent. Alkaline metal or alkaline earth metal hydroxide will carry out this transformation in an aqueous media (neutralization of an acid with these bases produces an inorganic salt and water). However, in the electronics industry the presence of inorganic salts are generally considered undesirable as they can lead to corrosion and will have a large impact on the conductivity of the system, which will vary with concentration.

To convert the PSS back to the PSSA after shipping, a strong acid must be added to the polymer solution to drive the equilibrium towards the polymeric acid. This is usually accomplished by the addition of sulfuric acid to the PSS, which produces the alkaline or alkaline earth metal sulfate, additional inorganic salts. A method (such as ion exchange) must be used to remove these salts from the polymer solution and then a second step is necessary to remove any excess acid. Both of these steps require handling, specific equipment and process time and are costly for the formulator to undertake.

There is a need to provide aqueous PSSA (co)polymer solutions without the need for low temperature refrigeration or for requiring the formulator to perform all the post processing steps, while ensuring that the polymer in solution has not undergone polymer degradation.

### SUMMARY

It is an object of the invention to at least partially meet the above-mentioned need in the art and to provide a stabilized form of PSSA (co)polymer in solution that can be transported and stored without the need for low temperature refrigeration, while maintaining the molecular weight of the polymer. The disclosure relates to a method of stabilizing the PSSA solution by addition of a phenolic compound in an amount that will effectively block any side reactions associated with PSSA polymers.

As part of this objective, the disclosure allows for the production of high molecular weight PSSA (co)polymers which provide excellent mechanical and electrical properties. Further, with a reduction or elimination of the side reactions, a more pure polymer solution can be obtained and made available to downstream formulators.

It is also the object of this invention to provide an “inorganic salt free” and “inorganic acid free” solution of the PSSA which would be extremely useful in the production of electronic devices.

### DETAILED DESCRIPTION

The invention relates to compositions that will afford stability to an aqueous solution of sulfonated polystyrene (SPS) polymers and co-polymers in their acid form. For purposes of this disclosure the term sulfonated polystyrene (SPS) is intended to mean any polymer containing styrene residues which have been treated to produce either sulfonic acid groups or the corresponding salt of the sulfonic acid attached directly to the styrene ring. The term polystyrene sulfonic acid (PSSA) hereinafter means polymers and copolymers which contain only the sulfonic acid attached directly to the styrene ring, while polystyrene sulfonate (PSS) is used to represent generally those (co)polymers in which the sulfonic acid salt is attached to the styrene ring. The sulfonate salt can be the product of the sulfonic acid with either alkali metal (group 1 metals) bases, alkali earth metals (group 2 metals) bases or ammonium salts. Preferred sulfonate salts are sodium, lithium, potassium and ammonium.

As defined for this invention, sulfonated styrene can also include sulfonated polymers made from substituted styrene. Non-limiting examples of such substituted styrene monomers are 2-chlorostyrene, 2,6-dichlorostyrene, 4-methylstyrene, 4-tert-butylstyrene, 4-vinyl biphenyl, 2-vinylnapthalene, 1-vinylnapthalene or 4-benzhydrylstyrene.

In addition to containing sulfonated styrene residues in the polymer chain, co-polymers of sulfonated styrene are also within the scope and breadth of this invention. Other monomer residues in the co-polymer may come from the co-polymerization of the styrene with any acrylic or vinylic monomers capable of being co-polymerized with the styrene. These include, but are not limited to, acrylic acid and methacrylic acid and their simple esters, vinyl acetate and other vinyl ester, crotonic acid, maleic and succinic acid and their anhydrides, acrylamide, octylacrylamide, t-butylacrylamide, and monomers containing tertiary or quaternary amine groups. Monomers that will lead to a cross-linked polymer can also be included, such as diethylene glycol dimethacrylate, diethylene glycol diacrylate (DEGDA), N,N-Diallylacrylamide, 2,2-Bis-[4-(2-acryloxyethoxy)phenyl]propane, 1-(acryloyloxy)-3-(methacryloyloxy)-2-propanol, triethylene glycol diacrylate (TriEGDA), and tricyclodecane dimethanol diacrylate. Also included in this disclosure are monomers that can be incorporated into the co-polymer that will allow the polymer to be further modified (such as derivatization or cross-linking) at some later time. These monomer residues are incorporated into the polymer by the use of monomers such as allyl glycidyl ether, allyl and vinyl silanes and siloxanes, 3-methacryloxypropyltrialkoxysilane, and other monomers containing latent function groups.

While it is generally accepted that SPS is prepared from polymers containing a styrene and then treated with sulfuric acid or sulfur trioxide, other methods for producing SPS have been reported. One such method for incorporating sulfonated styrene residues into a polymer is the atom transfer radical polymerization (ATRP) of protected styrenesulfonates (see for example “Polymerization of Styrene Sulfonate Ethyl Ester by ATRP: Synthesis and Characterization of Macromonomers for Suzuki Polycondensation,” Macromolecular Chemistry and Physics 207 (22): 2006.) Regardless of how the sulfonated styrene residues are incorporated into the polymer or co-polymer, they are all within the scope of this disclosure.

It has now been found that the use of certain phenolic compounds, when introduced into an aqueous solution of PSSA, provide a stabilizing effect on the molecular weight of the polymer or co-polymers which is maintained for significant periods of time at ambient or elevated temperature conditions. Samples have been stored for up to one year without any noticeable change in molecular weight at about 25° C. Ambient conditions is defined to be from about 5 to about 50° C. and approximately atmospheric pressure (1 bara or about 100,000 Pa). In an embodiment the temperature will be between about 10 and 40° C., or about 20 and 30° C.

Aqueous solutions of PSSA typically contain from about 1 to about 50 percent of the polymer (by weight dry basis) in water. In an embodiment of this invention the solutions of PSSA contain from about 5 to about 40, about 7 to about 30, or about 10 to about 20 weight percent of the polymer in an aqueous solution.

The phenolic stabilizing compound can be one of a series of substituted phenol compounds. Non-limiting examples of phenolic stabilizing compounds are eugenol, gallic acid, syringic acid, carvacrol, thymol, 2-methoxyphenol, 4-methoxyphenol and p-nitrosophenol, and dinitro-orthocresol, 2,4-dinitro-6-sec butyl phenol, 2,4-dinitrophenol, butylated hydroxytoluene (BHT), and 2,4-dinitro-p-cresol. Two factors need to be considered in the choice of the PSSA solution stabilizer. The first is the solubility of the stabilizer in the aqueous phase. While a high concentration of the stabilizer in the polymer solution is not required to afford a stable polymer molecular weight, it is important that the stabilizer will not phase separate or crystallize from solution after a period of time.

The second factor is the electronics of the phenol derivative. In an embodiment of the invention a phenol derivative with an electron donating group is used. Preferably the PSSA solution stabilizer is 4-methoxyphenol.

The choice of PSSA solution stabilizer will vary with the ambient temperature, polymer concentration and length of storage along with other possible variables. To this end, an effective amount of stabilizer needs to be added to the solution to prevent degradation, while preferably using the minimum level to reduce the potential for interference with polymer performance (at higher levels these stabilizers can act as plasticizers and de-bonders).

The effective level of stabilizer will be between 50 and 5000 ppm based on the total weight of the solution. In an embodiment of this invention, the stabilizer will be present in the solution at about 100 to about 2500 ppm. In yet another embodiment, the stabilizer will be present at a concentration of about 75 to 4000 ppm, 85 to 3000 ppm, 100 to about 1000 ppm, or 500 to 1000 ppm based on the total weight of the solution.

When an effective amount of the stabilizer is added to the PSSA solution, there is minimal change in the molecular weight of the polymer over time. Molecular weight is discussed herein as the weight average molecular weight, Mw. Percentage change in molecular weight is defined as the difference between the original molecular weight and the new molecular weight divided by the original molecular weight, which can be calculated, for example, by (initial Mw−new Mw)/initial Mw*100. Molecular weights are calculated as measured by GPC. Without the addition of a stabilizer, a PSSA in solution can lose a significant amount of its initial molecular weight over time. With the addition of an effective amount of stabilizer, the change of molecular weight is preferably less than about 25% from the initial molecular weight after 90 days of storage at 25° C. In an embodiment of this invention, the molecular weight will drop less than about 10% after 12 months at 25° C. In an embodiment of this invention, the molecular weight will drop less than about 25% after 12 months at 25° C. In another embodiment, the change in molecular weight will be less than about 10% after 12 months at 25° C. In yet another embodiment of this invention, the molecular weight will drop less than about 5% of the initial molecular weight after 12 months at 25° C. In yet another embodiment of this invention, the initial Mw of the PSSA in the solution is not decreased after 90 days, 2 months or 12 months of storage at 25° C.

When a ratio or amount is given, it is by weight, unless mentioned differently.

A decrease of a parameter is considered to be absent if the numerical value of the relevant property is not decreased or decreased with less than 10%.

The present invention will now be illustrated by the following non-limiting examples. Throughout this document, unless indicated differently, the weight percentages of the compositions are based on the total weight of the composition, whereby the total weight of the composition is 100 wt %. The term water-soluble is used for materials that dissolve in an amount of at least 1 g per liter of demineralized water at 25° C. Where used, the term “consisting” also embraces “consisting substantially”, but may optionally be limited to its strict meaning of “consisting entirely”.

Throughout the description and claims of this specification, the words “comprise” and “contain” and variations of the words, for example “comprising” and “comprises”, mean “including but not limited to”, and do not exclude other moieties, additives, components, integers or steps. Moreover the singular encompasses the plural unless the context otherwise requires: in particular, where the indefinite article is used, the specification is to be understood as contemplating plurality as well as singularity, unless the context requires otherwise.

Where upper and lower limits are quoted for a property, for example for the concentration of a component, then a range of values defined by a combination of any of the upper limits with any of the lower limits may also be implied.

It will also be appreciated that features from different aspects and embodiments of the invention may be combined with features from any other aspect and embodiment of the invention.

### EXPERIMENTAL

All samples of polystyrene sulfonic acid were freshly prepared in the laboratory by direct sulfonation of polystyrene with liquid sulphur trioxide.

Over a two-year period, five individual batches of Mw of about 1,000,000 Dalton PSSA and two individual batches with PSSA having a Mw of about 200K Dalton were tested at various times.

Determination of weight average molecular weight (M_{w}) was accomplished using Agilent LC 1260 system with a UV detector. The columns were ZORBAX PSM 300 and ZORBAX PSM 1000 (6.2 mm*250 mm, 5 um particle size, both available from Agilent Technologies, 5301 Stevens Creek Blvd, Santa Clara). The solvent was prepared by adding 25 mmole of ammonium formate to a mixture of 80% water and 20% acetonitrile. The flow rate through the column was 0.75 mL/min and the UV detector was set a 254 nm. The injected sample volume for each run was 10 μL.

Three polystyrene sulfonate standards (order number STD20100, Jordi Labs LLC, Bellingham, Mass.) were prepared at ˜2.0 mg/ml: M 679 k PSS+65.4 k PSS+6.43 k PSS; 305 k PSS+33.5 k PSS+3.42 k PSS; 1020 k PPS+0.891 k PPS. A 3rd regression was used for calibration.

### Example 1—Degradation of High Mw Comparative Samples without Stabilizer

Samples of un-stabilized PSSA solutions were freshly prepared at around 5 to 10% of the polymer, by weight, in distilled water (except the sample labeled anhydrous which was tested as a dry powder) and then stored under the specified conditions. High M_{w} Sample A had an initial M_{w} of about 1,065 (kDa), and High M_{w} Sample B had an initial M_{w} of about 1,097 (kDa). A solid anhydrous Sample C having an initial M_{w} of about of 1116 (kDa) was also prepared. These Samples A, B and C were analyzed over time as set forth below in Table 1.

The freshly prepared solutions had a pH of about 1. Samples labeled RT were stored on the bench for the noted amount of time under ambient light conditions (away from direct sunlight, but not protected from incident light). Samples for the 40° C. condition were maintained in an oven which had no light source. The refrigerated samples, 4° C. and −12° C., were also stored in the dark for the duration of the aging study. At the prescribed times the samples were removed from their storage location and a 10 μL samples was extracted and analyzed by GPC. The results are shown in Table 1, below.

TABLE 1
Effect of Aging on High M_{w} PSSA Solutions Without Stabilizer

| Analysis | M_{w} | Days | | | Level of |
|---|---|---|---|---|---|
| # | (kDa) | aged | Storage Conditions | | stabilizer |
| Sample A | 1,065 | 0 | Initial | | 0 PPM |
| 2 | 774 | 16 | 25 | C./light | 0 PPM |
| 3 | 614 | 31 | 25 | C./light | 0 PPM |
| 4 | 482 | 45 | 25 | C./light | 0 PPM |
| 5 | 446 | 58 | 25 | C./light | 0 PPM |
| 6 | 180 | 176 | 25 | C./light | 0 PPM |
| Sample A | 1,065 | 0 | Initial | | 0 PPM |
| 7 | 764 | 16 | 40° | C./dark | 0 PPM |
| 8 | 566 | 31 | 40° | C./dark | 0 PPM |
| 9 | 486 | 45 | 40° | C./dark | 0 PPM |
| 10 | 425 | 58 | 40° | C./dark | 0 PPM |
| 11 | 301 | 176 | 40° | C./dark | 0 PPM |
| Sample A | 1,065 | 0 | Initial | | 0 PPM |
| 12 | 1,097 | 16 | 4° | C./dark | 0 PPM |
| 13 | 949 | 31 | 4° | C./dark | 0 PPM |
| 14 | 946 | 45 | 4° | C./dark | 0 PPM |
| 15 | 946 | 58 | 4° | C./dark | 0 PPM |
| 16 | 786 | 100 | 4° | C./dark | 0 PPM |
| 17 | 553 | 176 | 4° | C./dark | 0 PPM |
| Sample A | 1,065 | 0 | Initial | | 0 PPM |
| 18 | 1,130 | 16 | −12° | C./dark | 0 PPM |
| 19 | 1,023 | 31 | −12° | C./dark | 0 PPM |
| 20 | 1,028 | 45 | −12° | C./dark | 0 PPM |
| 21 | 1,050 | 58 | −12° | C./dark | 0 PPM |
| 22 | 1,007 | 176 | −12° | C./dark | 0 PPM |
| 23 | 1,010 | 379 | −12° | C./dark | 0 PPM |
| 24 | 1,061 | 676 | −12° | C./dark | 0 PPM |
| Sample C | 1116 | 0 | 25° | C./light | 0 PPM |
| (anhydrous) | | | | | |
| 26 | 929 | 16 | 25° | C./light | 0 PPM |
| 27 | 1010 | 31 | 25° | C./light | 0 PPM |
| 28 | 986 | 45 | 25° | C./light | 0 PPM |
| 29 | 862 | 58 | 25° | C./light | 0 PPM |
| 30 | 850 | 176 | 25° | C./light | 0 PPM |
| Sample B | 1097 | 0 | Initial | | 0 PPM |
| 32 | 875 | 16 | 25° | C./Dark | 0 PPM |
| 33 | 757 | 31 | 25° | C./Dark | 0 PPM |
| 34 | 677 | 45 | 25° | C./Dark | 0 PPM |
| 35 | 379 | 176 | 25° | C./Dark | 0 PPM |
| Sample B | 1097 | 0 | Initial | | 0 PPM |
| 36 | 995 | 16 | 25° | C./Dark/N2 | 0 PPM |
| 37 | 890 | 31 | 25° | C./Dark/N2 | 0 PPM |
| 38 | 762 | 45 | 25° | C./Dark/N2 | 0 PPM |
| 39 | 1097 | 0 | 25° | C./light/N2 | 0 PPM |
| 40 | 858 | 16 | 25° | C./light/N2 | 0 PPM |
| 41 | 741 | 31 | 25° | C./light/N2 | 0 PPM |
| 42 | 597 | 45 | 25° | C./light/N2 | 0 PPM |
| Sample B | 1097 | 0 | Initial | | 0 PPM |
| 43 | 887 | 16 | 40° | C./Dark/N2 | 0 PPM |
| 44 | 707 | 31 | 40° | C./Dark/N2 | 0 PPM |
| 45 | 557 | 45 | 40° | C./Dark/N2 | 0 PPM |

The test with anhydrous powder shows the inherent instability of the PSSA.

From the data in table 1, it can be seen that the comparative samples lost significant M_{w} over the course of the first 6 months with the exception of those stored frozen in the dark at −12° C.

### Example 2—Effectiveness of Phenolic Stabilizers with High Mw PSSA Samples

A solution of high molecular weight PSSA was prepared in the same manner as described in experiment 1 (above) and a stabilizing agent was added to the initial solution at the prescribed concentration. Simple mechanical stirring was used to mix the PSSA solution and the stabilizing agent. The samples were once again stored on the lab bench top under ambient light conditions (away from direct sunlight, but not protected from incident light). Small aliquots of material were removed from the vial to be used in GPC measurements of the M_{w} as reported in Table 2, below.

TABLE 2
Effect of Stabilizer on High M_{w} PSSA Solutions

| Analysis | M_{w} | Days | | Level of |
|---|---|---|---|---|
| # | (Kda) | aged | Stabilizer/Temp | stabilizer |
| Sample A | 1,065 | 0 | Initial | |
| 46 | 1,086 | 16 | BHT/25° C. | 2500 PPM |
| 47 | 974 | 31 | BHT/25° C. | 2500 PPM |
| 48 | 910 | 45 | BHT/25° C. | 2500 PPM |
| 49 | 878 | 58 | BHT/25° C. | 2500 PPM |
| Sample A | 1,065 | 0 | Initial | |
| 50 | 1,094 | 16 | 4MP/25° C. | 2500 PPM |
| 51 | 990 | 31 | 4MP/25° C. | 2500 PPM |
| 52 | 969 | 45 | 4MP/25° C. | 2500 PPM |
| 53 | 972 | 58 | 4MP/25° C. | 2500 PPM |
| 54 | 855 | 176 | 4MP/25° C. | 2500 PPM |
| Sample A | 1,065 | 0 | Initial | |
| 55 | 836 | 100 | 4MP/25° C. | 2000 PPM |
| 56 | 740 | 379 | 4MP/25° C. | 2000 ppm |
| 57 | 826 | 100 | 4MP/25° C. | 1000 PPM |
| 58 | 845 | 100 | 4MP/25° C. | 500 PPM |
| 59 | 790 | 306 | 4MP/25° C. | 500 PPM |
| 60 | 746 | 603 | 4MP/25° C. | 500 PPM |

BHT = butylated hydroxytoluene
4MP = 4-methoxyphenol

The results in table 2 show that stabilizers can reduce the loss of M_{w} on PSSA polymers in solution. The samples of PSSA that we treated with 2500 ppm of BHT (butylated hydroxytoluene) lost roughly 20% of the M_{w} of the initial polymer over the course of 2 months, while samples treated with 4-methoxyphenol lost roughly 10% of the initial M_{w} in the same time frame. Both stabilizers exhibited significant improvement over samples lacking stabilizers. As shown in Table 2, the 4-methoxyphenol is effective over a broad concentration range of between 2500 to 500 ppm.

### Example 3—Degradation of Medium Mw Comparative Samples without Stabilizer

Samples were prepared and analyzed as described in Example 1 except using PSSA having a medium molecular weight. Medium Mw Sample D had an initial Mw of about 219 (Kda). A solid anhydrous Sample E having an initial Mw of about of 227 (Kda) was also prepared.

TABLE 3
Effect of Aging on Medium M_{w} PSSA Solutions Without Stabilizer

| Analysis | M_{w} | Days | | | Level of |
|---|---|---|---|---|---|
| # | (Kda) | aged | Storage Conditions | | stabilizer |
| Sample D | 219 | 0 | Initial | | 0 PPM |
| 62 | 194 | 15 | 25° | C./light | 0 PPM |
| 63 | 173 | 29 | 25° | C./light | 0 PPM |
| 64 | 162 | 42 | 25° | C./light | 0 PPM |
| 65 | 141 | 160 | 25° | C./light | 0 PPM |
| Sample D | 219 | 0 | Initial | | 0 PPM |
| 66 | 183 | 15 | 40° | C./dark | 0 PPM |
| 67 | 170 | 29 | 40° | C./dark | 0 PPM |
| 68 | 157 | 42 | 40° | C./dark | 0 PPM |
| 69 | 146 | 160 | 40° | C./dark | 0 PPM |
| Sample D | 219 | 0 | Initial | | 0 PPM |
| 70 | 210 | 15 | 4° | C./dark | 0 PPM |
| 71 | 202 | 29 | 4° | C./dark | 0 PPM |
| 72 | 197 | 42 | 4° | C./dark | 0 PPM |
| 73 | 195 | 160 | 4° | C./dark | 0 PPM |
| Sample D | 219 | 0 | −12° | C./dark | 0 PPM |
| 74 | 204 | 15 | −12° | C./dark | 0 PPM |
| 75 | 199 | 29 | −12° | C./dark | 0 PPM |
| 76 | 197 | 42 | −12° | C./dark | 0 PPM |
| 77 | 205 | 160 | −12° | C./dark | 0 PPM |
| 78 | 206 | 363 | −12° | C./dark | 0 PPM |
| Sample D | 219 | 0 | Initial | | 0 PPM |
| 79 | 208 | 15 | 25° | C./light/N2 | 0 PPM |
| 80 | 203 | 29 | 25° | C./light/N2 | 0 PPM |
| 81 | 195 | 42 | 25° | C./light/N2 | 0 PPM |
| Sample D | 219 | 0 | Initial | | 0 PPM |
| 82 | 211 | 15 | 25° | C./dark/N2 | 0 PPM |
| 83 | 201 | 29 | 25° | C./dark/N2 | 0 PPM |
| 84 | 192 | 42 | 25° | C./dark/N2 | 0 PPM |
| Sample D | 219 | 0 | Initial | | 0 PPM |
| 85 | 220 | 100 | 4° | C./dark | 0 PPM |
| Sample E | 227 | 0 | 25° | C./light | 0 PPM |
| (anhydrous) | | | | | |
| 87 | 212 | 15 | 25° | C./light | 0 PPM |
| 88 | 207 | 29 | 25° | C./light | 0 PPM |
| 89 | 205 | 42 | 25° | C./light | 0 PPM |

Tested as the anhydrous powder to show the inherent instability of the PSSA.

The results above show that at RT or above approximately 30% of the initial molecular weight of the PSSA polymer was lost in 42 days, whereas under refrigerated or frozen conditions the molecular weight was maintained for over 6 months.

### Example 4—Effectiveness of Phenolic Stabilizers with Medium Mw PSSA Samples

A sample of a medium molecular weight PSSA polymer solution was prepared and analyzed as described in Examples 1 and 2, above. 4-Methoxyphenol was added to the solution to bring the total concentration to 500 ppm and then the sample was aged at RT and under ambient lighting conditions. Simple mechanical stirring was used to mix the PSSA polymer solution and the 4-methoxyphenol.

TABLE 4
Effect of stabilizer on medium M_{w} PSSA Solutions.

| Analysis | M_{w} | Days | | | Level of | |
|---|---|---|---|---|---|---|
| # | (Kda) | aged | Storage Conditions | | stabilizer | |
| Sample | 219 | 0 | initial | | | |
| D | | | | | | |
| 90 | 203 | 305 | 4MP/25° | C./light | 500 | ppm |
| 91 | 199 | 602 | 4MP/25° | C./light | 500 | ppm |
| 92 | 178 | 734 | 4MP/25° | C./light | 500 | ppm |
| 93 | 207 | 112 | 4MP/25° | C./light | 500 | ppm |
| 94 | 203 | 297 | 4MP/25° | C./light | 500 | ppm |
| 95 | 172 | 112 | 25° | C./light | 0 | PPM |
| 96 | 142 | 297 | 25° | C./light | 0 | PPM |

From the data in table 4, it was demonstrated that the stability of the PSSA polymer solutions containing 500 PPM 4-methoxyphenol were roughly equivalent to those stored refrigerated or frozen for greater than 6 months.

### Example 5—Effect of Stabilization Concentration on Polymer Stability

Samples of high Mw PSSA were prepared and analyzed as in experiments 1 and 2 above.

TABLE 5
Effect of Stabilizer Concentration on Polymer Stability

| Analysis | M_{w} | Days | | | Level of |
|---|---|---|---|---|---|
| # | (Kda) | aged | Stabilizer/Temp | | stabilizer |
| Sample | 1097 | 0 | initial | | |
| B | | | | | |
| 97 | 629 | 90 | 25° | C./light | 0 PPM |
| 98 | 1070 | 90 | 4MP/25° | C./light | 100 PPM |
| 100 | 1013 | 90 | 4MP/40° | C./light | 500 PPM |
| 99 | 1011 | 90 | 4MP/25° | C./light | 700 PPM |

The results of table 5 show that excellent stability of the high molecular weight PSSA solutions can be obtained for at least 90 days with levels of 4-methoxyphenol of 100 PPM or greater.

1. A composition comprising an aqueous solution of a polystyrene sulfonic acid and a phenolic stabilizing compound in a concentration from 50 ppm to 5000 ppm which is stable, meaning that the weight average molecular weight of the polystyrene sulfonic acid in solution is lowered less than 25% after storage at 25° C. for 90 days.

2. The composition of claim 1 wherein the concentration of the polystyrene sulfonic acid in the aqueous solution is from about 1 to about 50 percent based on the dry weight of the polystyrene sulfonic acid and the aqueous solution contains at least 50 percent water.

3. The composition of claim 1 wherein the initial weight average molecular weight of the polystyrene sulfonic acid is at least 200,000 Dalton.

4. The composition of claim 1 wherein the phenolic stabilizing compound is present in a concentration from 100 ppm to 2500 ppm, more preferably from 500 ppm to 1000 ppm.

5. The composition of claim 1 wherein the phenolic stabilizing compound comprises an electron donating group.

6. The composition of claim 1 wherein the phenolic stabilizing compound is soluble in the aqueous solution of the composition.

7. The composition of claim 1 wherein the phenolic stabilizing compound is 4-methoxyphenol.

8. The composition of claim 1 wherein the weight average molecular weight of the polystyrene sulfonic acid in solution is maintained within about 25% of the initial weight average molecular weight after storage at 25° C. and 12 months.

9. The composition of claim 1 wherein the aqueous solution comprises a sulfuric acid content of less than about 0.1 wt %.

10. A composition of claim 1 comprising an aqueous solution of a polystyrene sulfonic acid having a weight average molecular weight of at least 200,000 Daltons, said aqueous solution having a sulfuric acid content of less than about 0.1 wt % and said solution comprising a phenolic stabilizing compound in a concentration range from about 100 ppm to about 1000 ppm.

11. The composition of claim 10 wherein the phenolic stabilizing compound is 4-methoxyphenol.

12. The composition of claim 1 wherein the aqueous solution comprises an inorganic salt content of less than about 0.1 wt %.

13. A method of stabilizing an aqueous solution of polystyrene sulfonic acid comprising combining said aqueous solution with a phenolic stabilizing compound in a concentration from 50 ppm to 5000 ppm of the solution which is stable as defined in claim 1.

14. The method of claim 13 wherein the phenolic stabilizing compound is 4-methoxyphenol.

15. The method of claim 14 wherein the 4-methoxyphenol is present at a concentration of from 100 to 5000 ppm, preferably from 100 to 2500 ppm, and more preferably from 500 to about 1000 ppm based on the total solution weight.
